(19) United States
(12) Patent Application Publication
(10) Pub. No.: US 2025/0330219 A1
(43) Pub. Date: Oct. 23, 2025

(54) LOW EARTH ORBIT SATELLITE COMMUNICATION METHOD AND SYSTEM USING FREQUENCY-DEPENDENT BEAMFORMING

(71) Applicant: KOREA UNIVERSITY RESEARCH AND BUSINESS FOUNDATION, Seoul (KR)

(72) Inventors: Won Jae SHIN, Seoul (KR); Ju Ha PARK, Suwon-si, Gyeonggi-do (KR)

(21) Appl. No.: 19/049,950

(22) Filed: Feb. 10, 2025

(30) Foreign Application Priority Data
Apr. 17, 2024 (KR) 10-2024-0051463
Oct. 7, 2024 (KR) 10-2024-0135991

(51) Int. Cl. H04B 7/06; H04L 43/0852; H04W 72/0453

(52) U.S. Cl. CPC H04B 7/0617; H04L 43/0852; H04W 72/0453

(57) ABSTRACT

Disclosed is a low Earth orbit satellite communication method and system using frequency-dependent beamforming. The low earth orbit satellite communication method using frequency-dependent beamforming includes: (a) forming frequency-dependent beamforming by adjusting at least one of a true time delay (TTD) and a phase shifter; and (b) searching a satellite or simultaneously providing a data service to multiple users by using the frequency-dependent beamforming, wherein the true time delay (TTD) is mandatory, while the phase shifter (PS) can be used optionally.

### CROSS-REFERENCE TO RELATED APPLICATION

This application claims the benefit of priority under 35 U.S.C. § 119(a) to Korean Patent Application Nos. 10-2024-0051463 filed on Apr. 17, 2024 and 10-2024-0135991 filed on Oct. 7, 2024, the entire contents of which are incorporated herein by reference.

### BACKGROUND

### (a) Technical Field

The present invention relates to a low earth orbit satellite communication method and system using frequency-dependent beamforming.

### (b) Background Art

In order to realize the hyper connectivity, ultra-high speed, and ultra-low latency required in a next-generation communication system after 5G, a wider bandwidth and wide-area coverage are needed at the same time. However, in order to support this through terrestrial networks, the movement to an mmWave/THz high frequency band is inevitable, which leads to reducing a single base station coverage due to excessive signal attenuation.

Low Earth orbit satellite communication in the next-generation communication system after 5G is a key technology for achieving a global coverage of a high-data rate. In the low earth orbital satellite communication, high-gain analog beamforming (BF) based on an array antenna is very important to overcome severe path loss. To meet the high throughput, technical progress from a current narrow band to broadband transmission is indispensable. While a study of terrestrial wideband communications such as mmWave/THz band communications is very active, the study of the wideband low Earth orbit satellite communication is still staying in the conventional narrowband assumption-based system design criterion.

A phased array antenna for the existing narrow band communication performs beamforming using multiple phase shifters (PS) by using the equivalence of a true time delay and a phase shift of a signal, but such an equivalence is not established for a wideband signal, so when this is used in the wideband system as it is, a beam-squint phenomenon in which a direction subcarriers face deviates from an intended direction occurs.

This is especially fatal in a satellite array antenna by using massive antenna elements to form a pencil-beam, and has a problem that leads to a decrease in high-gain beamforming performance.

### SUMMARY OF THE DISCLOSURE

The present invention is to provide a method and a system capable of efficient initial satellite access and satellite search by using frequency-dependent beamforming and a time-varying Doppler.

Further, the present invention is to provide a low Earth orbit satellite communication method and system using frequency-dependent beamforming capable of data communication by beams heading to different directions according to a specific frequency based on the time-varying Doppler.

Further, the present invention is to provide a low Earth orbit satellite communication method and system using frequency-dependent beamforming capable of accessing multiple satellites through forming a frequency-dependent beam pattern.

Further, the present invention is to provide a low Earth orbit satellite communication method and system using frequency-dependent beamforming capable of significantly improving an uplink throughput and a coverage which are technical limits of the low Earth orbit satellite communication.

According to an aspect of the present invention, there is provided a low Earth orbit satellite communication method using frequency-dependent beamforming.

According to an embodiment of the present invention, there is provided a low earth orbit satellite communication method using frequency-dependent beamforming, which includes: (a) forming frequency-dependent beamforming by adjusting a true time delay (TTD) and a phase shifter; and (b) searching a satellite or simultaneously providing a data service to multiple users by using the frequency-dependent beamforming.

The searching of the satellite by using the frequency-dependent beamforming may include receiving signals from satellites by using the frequency-dependent beamforming; and simultaneously amplifying signals received in different directions and at different frequencies from the satellites through the frequency-dependent beamforming by adjusting true time delay and phase, then, accessible satellites are detected through single-shot peak detection in the frequency domain.

In step (a) above, frequency-dependent beamforming may be formed by presetting values of the true time delay (TTD) and/or the phase shifter by using a Doppler shift pre-calculated based on orbit information of a plurality of satellites.

The searching of the satellite by using the frequency-dependent beamforming may include: determining an access target satellite based on the satellite search result; acquiring ephemeris data for satellites, and determining a true time delay (TTD) value and a value of the phase shifter (PS) value by using the ephemeris data for the satellites; and performing data communication by forming a frequency-dependent beam pattern through transmission/reception frequency-dependent beamforming using the determined true time delay (TTD) and/or phase shifter (PS) values.

In the performing of the data communication by forming a frequency-dependent beam pattern through the transmission/reception frequency-dependent beamforming, the data communication may be performed by forming a beam pattern fixed at a frequency band of the access target satellite by adjusting the true time delay (TTD) value and/or the phase shifter (PS) value based on orbit information and a relative speed of the access target satellite.

In the simultaneously providing of the data service to multiple users by using the frequency-dependent beamforming, a frequency-dependent beamforming may be formed by adjusting the true time delay (TTD) and/or the phase shifter using a Doppler shift pre-calculated based on location information of a ground station.

According to another aspect of the present invention, there is provided a system for a low Earth orbit satellite communication using frequency-dependent beamforming.

According to an embodiment of the present invention, there is provided a communication system, which includes: a plurality of antennas; a plurality of phase shifters connected to respective antennas, respectively; a plurality of true time delays (TTDs) connected to the respective phase shifters, wherein the true time delays (TTDs) and the phase shifters are connected to each other; an RF chain module processing a transmitted or received signal; and a signal processing unit controlling frequency-dependent beamforming to be formed by adjusting values of the true time delay (TTD) and/or the phase shifter according to respective frequencies by using a Doppler shift pre-calculated based on orbit information of a plurality of satellites, and when signals are received from satellites through the antenna and the RF chain module by using the frequency-dependent beamforming, controlling a satellite to be searched by readjusting values of the true time delays (TTD) and/or the phase shifter so as to simultaneously amplify signals received in different directions and at different frequencies from the satellites by adjusting the true time delay and the phase.

According to another embodiment of the present invention, there is provided a satellite communication system, which includes: a plurality of antennas; a plurality of phase shifters connected to respective antennas, respectively; a plurality of true time delays (TTDs) connected to the respective phase shifters, wherein the true time delays and the phase shifters are connected to each other; an RF chain module processing a transmitted or received signal; and a signal processing unit controlling frequency-dependent beamforming to be formed by adjusting each of values of the true time delay (TTD) and/or the phase shifter so as to simultaneously amplify signals in different directions and at different frequencies by adjusting true signal delay and phase, and simultaneously provide a data service to multiple users by performing the frequency-dependent beamforming.

According to an embodiment of the present invention, there is provided a low earth orbit satellite communication method and system using frequency-dependent beamforming, thereby enabling data communication by frequency-dependent beams heading to different directions according to time-varying Doppler shift.

Further, the present invention has advantages in that efficient initial satellite access and satellite search of low earth orbit satellite communication are possible by using frequency-dependent beamforming and a Doppler, and access to multiple satellites is possible.

In addition, the present invention has also an advantage in that an uplink throughput and a coverage, which are technical limits of the low earth orbit satellite communication, can be significantly improved.

### BRIEF DESCRIPTION OF THE DRAWINGS

FIG. 1 is a flowchart illustrating a low earth orbit satellite communication method using frequency-dependent beamforming according to an embodiment of the present invention.

FIG. 2 is a diagram shown to describe a satellite search method in a conventional time domain.

FIG. 3 is a diagram shown to describe phase search in a frequency domain according to an embodiment of the present invention.

FIG. 4 is a diagram shown to describe beamforming for data transmission in the related art.

FIG. 5 is a diagram shown to describe beamforming for data transmission according to an embodiment of the present invention.

FIG. 6 is a diagram shown to describe multi-satellite access according to an embodiment of the present invention.

FIG. 7 is a flowchart illustrating a low Earth orbit satellite communication method according to another embodiment of the present invention.

FIG. 8 is a diagram shown to describe conventional beam hopping systems.

FIG. 9 is a diagram shown to describe multi-user access in a frequency domain according to an embodiment of the present invention.

FIG. 10 is a diagram schematically showing a communication system according to an embodiment of the present invention.

### DETAILED DESCRIPTION

A singular form used in this specification includes a plural form unless the context clearly indicates otherwise. In this specification, the term such as “comprising” or “including” should not be interpreted as necessarily including all various components or various steps disclosed in this specification, and it should be interpreted that some components or some steps among them may not be included or additional components or steps may be further included. In addition, the terms “ . . . unit”, “module”, and the like disclosed herein mean a unit that processes at least one function or operation and this may be implemented by hardware or software or a combination of hardware and software.

Hereinafter, an embodiment of the present invention will be described in detail with reference to the accompanying drawings.

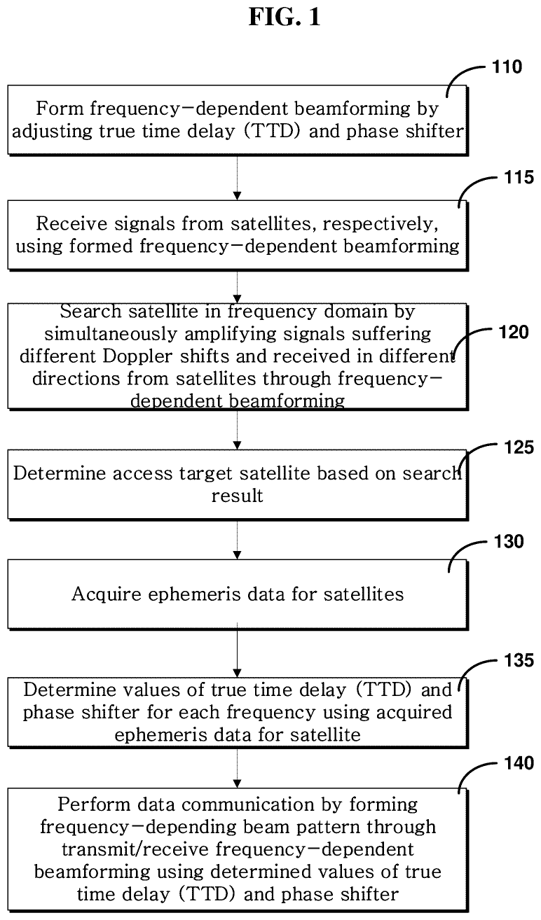

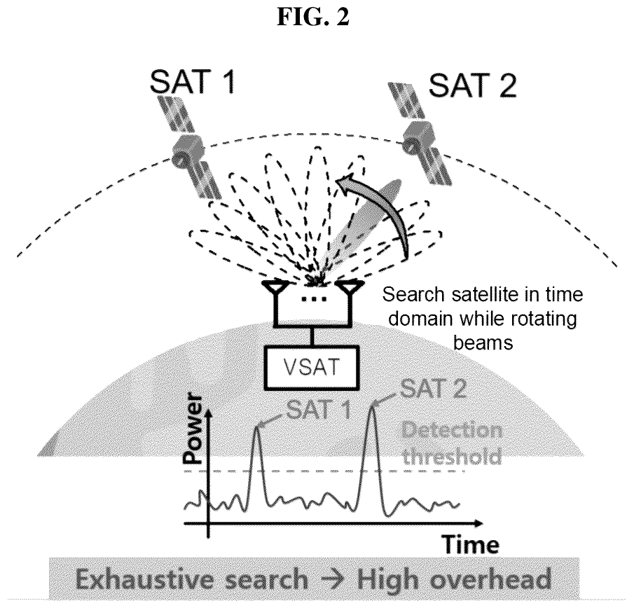

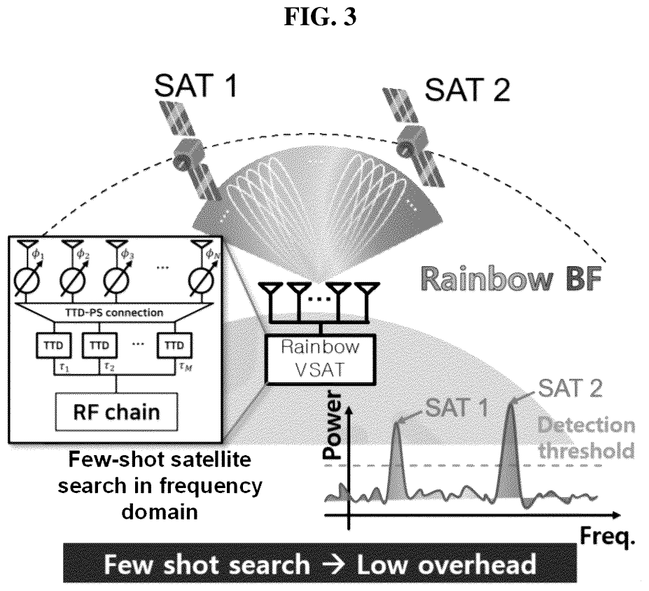

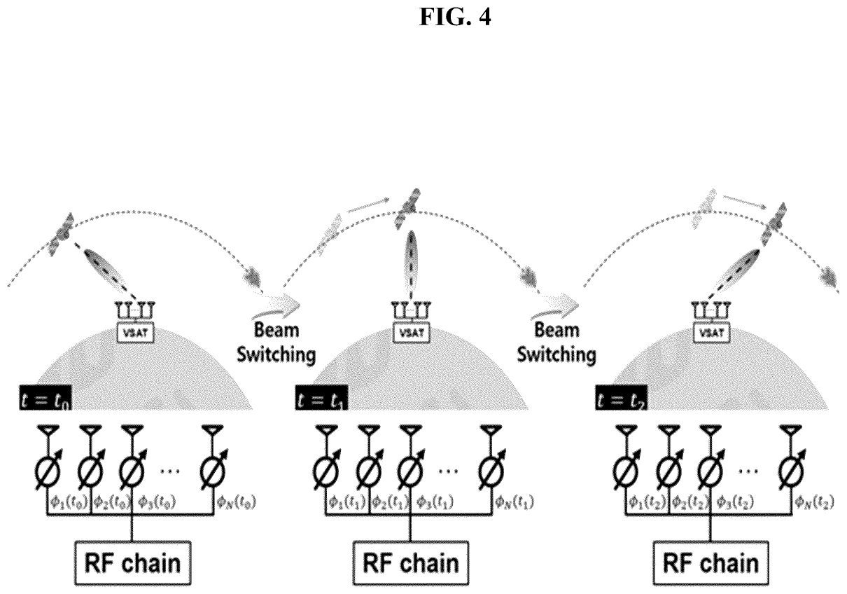

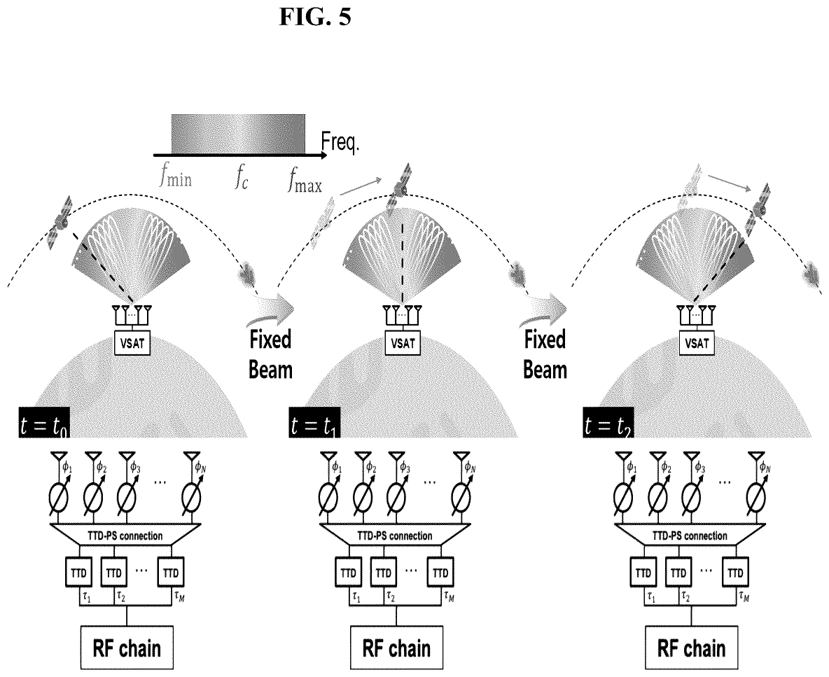

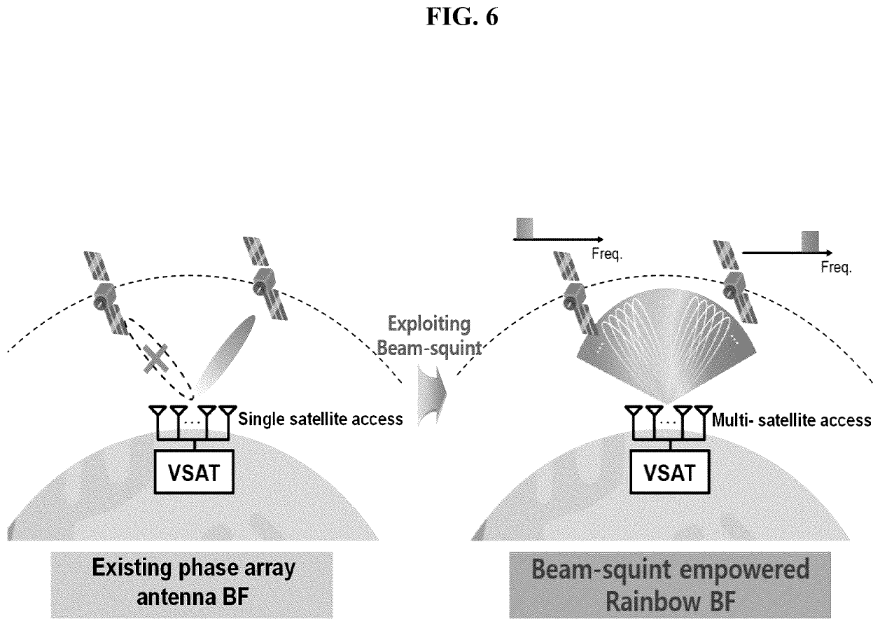

FIG. 1 is a flowchart illustrating a low earth orbit satellite communication method using frequency-dependent beamforming according to an embodiment of the present invention, FIG. 2 is a diagram shown to describe a satellite search method in a conventional time domain, FIG. 3 is a diagram shown to describe phase search in a frequency domain according to an embodiment of the present invention, FIG. 4 is a diagram shown to describe beamforming for data transmission in the related art, FIG. 5 is a diagram shown to describe beamforming for data transmission according to an embodiment of the present invention, and FIG. 6 is a diagram shown to describe multi-satellite access according to an embodiment of the present invention. Hereinafter, a method which performs communication by detecting a low earth orbit satellite in a ground station will be described. Accordingly, respective steps described below will be appreciated as a ground station communication system.

In step 110, a communication system 1000 adjusts a true time delay (TTD) and/or a phase shifter to form frequency-dependent beamforming.

The communication system 1000 may adjust the true time delay (TTD) and/or the phase shifter (PS) using ephemeris data from satellite orbits.

In this case, the communication system 1000 may calculate each Doppler shift in advance based on orbit information of a satellite, and then adjust values of the true time delay (TTD) and/or the phase shifter (PS) by using the calculated Doppler shift to form the frequency-dependent beamforming. The true time delay (TTD) is mandatory, while the phase shifter (PS) can be used optionally.

In step 115, the communication system 1000 may receive signals from satellites, respectively, by using the formed frequency-dependent beamforming.

Since a reference signal transmitted from the satellite suffers severe path loss, effective satellite search and access requires signal amplification and beamforming at the ground station. In the case of a satellite phase array antenna in the related art, the number of simultaneously active beam is limited, so the satellite is searched through exhaustive search in a time domain by dynamically switching the beams. In addition, unlike terrestrial communication, 2-dimensional (2D) search (azimuth and elevation angle) is required in the satellite communication, so there is a disadvantage in that it is inefficient and a search overhead problem is caused in terms of the ground station communication system (see FIG. 2).

However, as in an embodiment of the present invention, by adjusting the values of the TTD and/or the phase shifter (PS) based on the Doppler shift pre-calculated through orbit information of the satellite that is known in advance, the frequency-dependent beamforming is formed, so as shown in FIG. 3, one for few-shot satellite search in a frequency domain is possible, and there is an advantage in that a bottleneck phenomenon due to the satellite search may be dramatically improved.

In step 120, the communication system 1000 suffers different Doppler shifts from satellites, and simultaneously amplifies signals received in different directions through the frequency-dependent beamforming to search the satellite in the frequency domain. Then, accessible satellites are detected through single-shot peak detection in the frequency domain.

The communication system 1000 may form the frequency-dependent beam pattern by readjusting the true time delay (TTD) and/or the phase for the signals received through the frequency-dependent beamforming to search the satellite.

Thereafter, in step 125, the communication system 1000 determines an access target satellite based on a search result.

In step 130, the communication system 1000 acquires ephemeris data for the satellites.

In step 135, the communication system 1000 may determine the true time delay (TTD) value and/or the phase shifter (PS) value by using the acquired ephemeris data for the satellites.

In step 140, the communication system 1000 performs data communication by forming the frequency-dependent beam pattern through transmission/reception frequency-dependent beamforming using the determined true time delay (TTD) and/or phase shifter (PS) values.

For example, the communication system 1000 may use the frequency-dependent beamforming by adjusting values of the true time delay (TTD) and/or the phase shifter (PS), and perform the data communication with a frequency-dependent beam.

Since a movement speed of a satellite is very fast due to the nature of a low earth orbit satellite, the beam is switched by adjusting the phase shifter (PS) value in real time according to the movement of the satellite as shown in FIG. 4 to perform the data communication in the related art.

However, in the present invention, as shown in FIG. 5, the data communication may be performed by using a fixed frequency-dependent beam even though the values of the true time delay (TTD) and/or the phase shifter (PS) are set in advance based on orbit information of a specific satellite and are not adjusted over time.

As yet another example, in the related art, as shown in FIG. 6, the communication system is possible to access only one satellite, but the communication system according to an embodiment of the present invention is possible through the frequency-dependent beamforming.

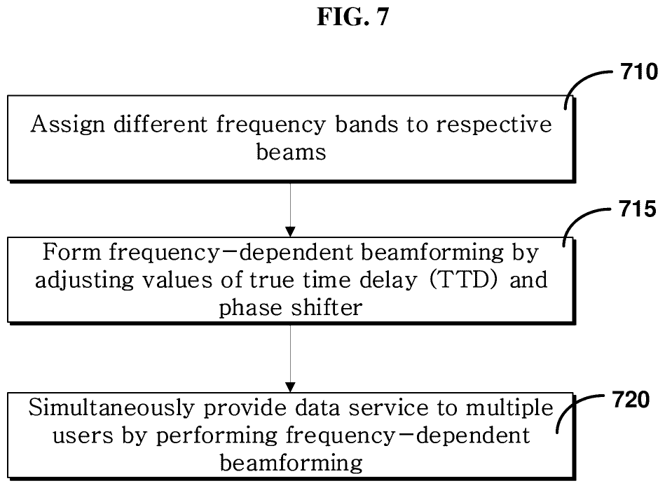

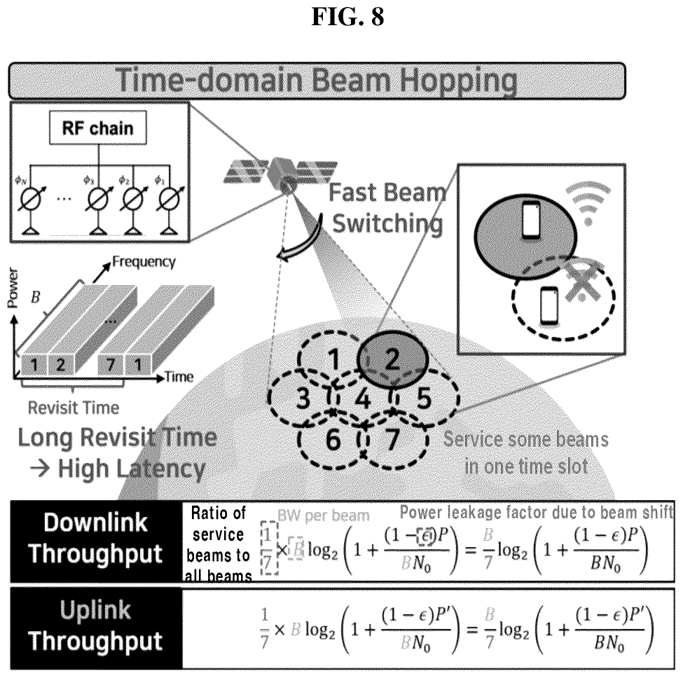

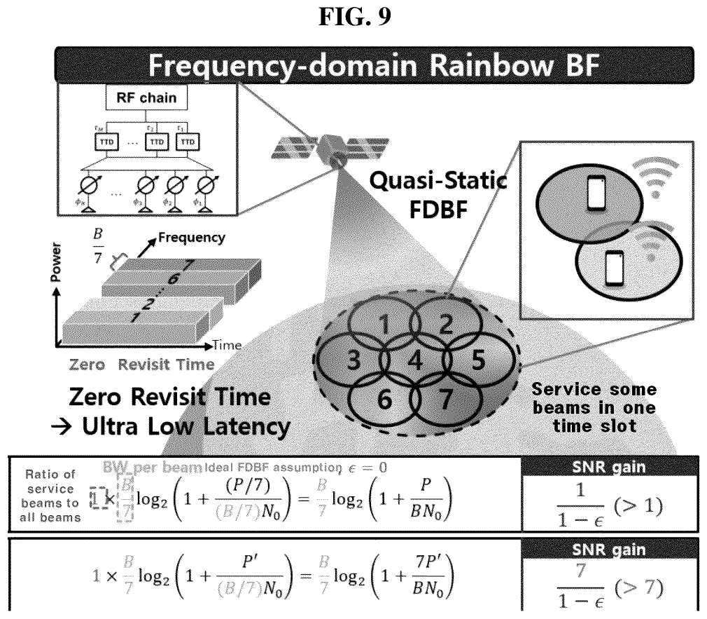

FIG. 7 is a flowchart illustrating a low Earth orbit satellite communication method according to another embodiment of the present invention, FIG. 8 is a diagram shown to describe conventional beam hopping systems, and FIG. 9 is a diagram shown to describe multi-user access in a frequency domain according to an embodiment of the present invention. Hereinafter, a method for providing a communication service to multiple users in a low Earth orbit satellite will be described.

In step 710, the satellite communication system 1000 assigns different frequency bands to respective beams.

In step 715, the satellite communication system 1000 forms frequency-dependent beamforming by adjusting values of a true time delay (TTD) and/or a phase shifter (PS).

A true time delay (TTD) and a phase shifter may be adjusted by using a pre-calculated Doppler shift based on location information of a ground station and/or traffic demands to form the frequency-dependent beamforming.

In step 720, the satellite communication system 1000 simultaneously provides a data service to multiple users by performing the frequency-dependent beamforming.

FIG. 8 is a diagram illustrating beam hopping in a time domain of the conventional satellite communication system.

In order for a satellite equipped with a small number of RF chain modules to provide a communication service to multiple ground stations which are distributed in a large area, a satellite communication system uses beam hopping using fast analog beam switching.

However, since the beam hopping should be designed by considering a traffic requirement different for each region and a border, the beam hopping is a technology having a very high complexity, and when a revisit time which is a time interval of servicing one beam and then servicing the corresponding beam again becomes longer, a communication latency becomes higher, which has a fatal impact on a decrease in quality of service (QOS).

However, as in an embodiment of the present invention, when the satellite communication system 1000 uses the frequency-dependent beamforming as shown in FIG. 9, the satellite communication system 1000 may provide a low-latency communication service with zero revisit time. Further, in the case of the beam hopping in the related art, all frequency resources are assigned to one beam in one existing time slot, while the satellite communication system 1000 according to an embodiment of the present invention may assign different frequency resources (bands) to respective beams and simultaneously service several beams in one time slot, so a signal-to-noise ratio (SNR) may be achieved, which is

$$\frac{{N}_{Beam}}{( 1 - ϵ ) {N}_{RF chain}}$$

times compared to the related art. Here, N_{RF chain}, N_{Beam}, and ε represent the number of RF chains (the number of beams which may be serviced in one time slot), the total number of beams in coverage, and a power leakage factor due to a beam-squint effects, respectively.

As in an embodiment of the present invention, there is an advantage in that the uplink throughput and the coverage, which are the technical limits of the low Earth orbit satellite communication, may be significantly improved by performing the satellite communication by using the frequency-dependent beamforming. Further, since the fast beam switching is not required like the conventional beam hopping technology in the time domain, a hardware design burden may be reduced.

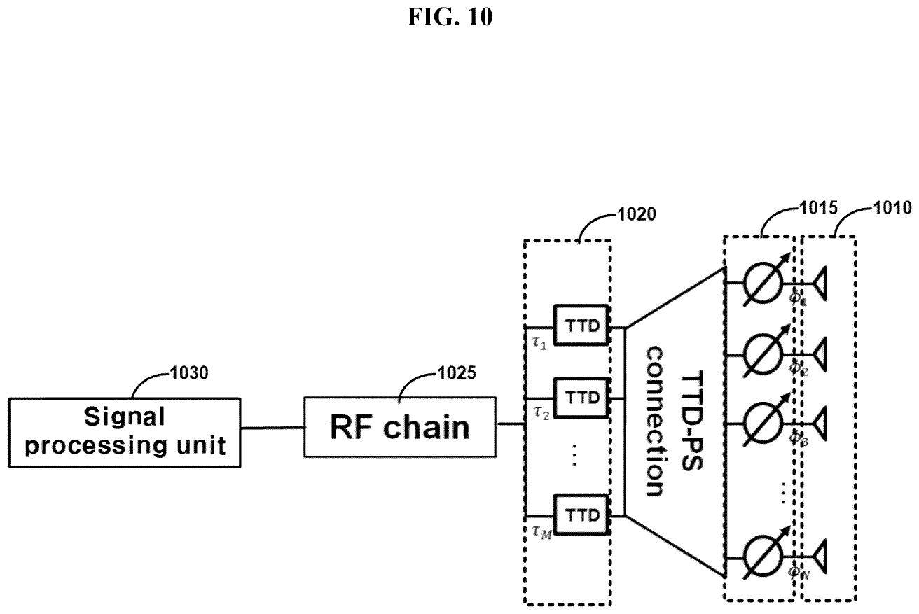

FIG. 10 is a diagram schematically showing a communication system according to an embodiment of the present invention. The communication system described below may be a ground station communication system or a satellite communication system.

Referring to FIG. 10, the communication system 1000 according to an embodiment of the present invention is configured to include a plurality of antennas 1010, a plurality of phase shifters 1015, a plurality of true time delays 1020, an RF chain module 1025, and a signal processing unit 1030.

The plurality of antennas 1010 may be connected to the plurality of phase shifters 1015, respectively.

The plurality of antennas may be phased array antennas.

The true time delays 1020 may be connected to the phase shifters 1015 of the phase array antennas, respectively.

The RF chain module 1025 may remove noise by amplifying and filtering signals, and enhance a quality of the signal. Subsequently, the communication system 1000 may convert an analog signal into a digital signal through an RF chain. Here, the RF chain may be a channel or a module. The RF chain as a signal processing path may be constituted by a plurality of circuits included in a transmitter and a receiver. That is, the RF chain may include a plurality of circuit devices such as an amplifier, a mixer, a local oscillator, a filter, an analog-digital converter, and a digital-analog converter, and signal processing at a transmitter and a receiver may be performed by using the circuit devices.

The signal processing unit 1030 may control frequency-dependent beamforming to be formed by adjusting values of the true time delay (TTD) and the phase shifter by using a pre-calculated Doppler shift based on orbit information of a plurality of satellites.

Further, when the signal processing unit 1030 receives signals from the satellites through the antenna and the RF chain module by using the frequency-dependent beamforming, the signal processing unit 1030 may control values of the true time delay (TTD) and/or the phase shifter so as to search the satellite in the frequency domain by simultaneously amplifying signals received in different directions and at different frequencies from the satellites through the frequency-dependent beamforming. Then, accessible satellites are detected through single-shot peak detection in the frequency domain.

As another example, when the communication system 1000 is the satellite communication system, the signal processing unit 1030 assigns different frequency bands to respective beams, and adjusts the values of the true time delay (TTD) and/or the phase shifters according to the respective frequency bands, respectively to form the frequency-dependent beamforming, and may also control a data service to be simultaneously provided to multiple users by performing the frequency-dependent beamforming.

The apparatus and the method according to embodiments of the present invention are implemented in a form of a program command which may be performed through various computer means, and may be recorded in the computer readable medium. The computer readable medium may include a program command, a data file, a data structure, and the like alone or in a combination thereof. The program commands recorded in the computer readable medium may be those specially designed and configured for the present invention, or may be those publicly known to and used by those skilled in the computer software field. Examples of the computer-readable recording medium include magnetic media such as a hard disk, a floppy disk, and a magnetic tape, optical media such as a CD-ROM and a DVD, magneto-optical media such as a floptical disk, and a hardware device, which is specifically configured to store and execute the program command, such as a ROM, a RAM, and a flash memory. An example of the program command includes a high-level language code executable by a computer using an interpreter and the like, as well as a machine language code created by a compiler.

The hardware device may be configured to be operated with one or more software modules in order to perform the operation of the present invention and vice versa.

The present invention has been described above with reference to the embodiments thereof. It is understood to those skilled in the art that the present invention may be implemented as a modified form without departing from an essential characteristic of the present invention. Therefore, the disclosed embodiments should be considered in an illustrative viewpoint rather than a restrictive viewpoint. The scope of the present invention is defined by the appended claims rather than the foregoing description, and all differences within the scope of equivalents thereof should be construed as being included in the present invention.

What is claimed is:

1. A low Earth orbit satellite communication method using frequency-dependent beamforming, comprising:
(a) forming frequency-dependent beamforming by adjusting at least one of a true time delay (TTD) and a phase shifter; and
(b) searching a satellite or simultaneously providing a data service to multiple users by using the frequency-dependent beamforming.

2. The low Earth orbit satellite communication method using frequency-dependent beamforming of claim 1, wherein the searching of the satellite by using the frequency-dependent beamforming includes:
receiving signals from satellites by using the frequency-dependent beamforming, and
searching the satellite by simultaneously amplifying signals received in different directions and at different frequencies from the satellites through the frequency-dependent beamforming by adjusting true time delay and phase, then accessible satellites are detected through single or few-shot peak detection in the frequency domain.

3. The low Earth orbit satellite communication method using frequency-dependent beamforming of claim 1, wherein in step (a) above, beams in different directions are formed for each frequency by presetting values of at least one of the true time delay (TTD) and the phase shifter using a Doppler shift pre-calculated based on orbit information of a plurality of satellites, the locations of ground stations, or traffic demands,
wherein the true time delay (TTD) is mandatory, while the phase shifter (PS) can be used optionally.

4. The low Earth orbit satellite communication method using frequency-dependent beamforming of claim 2, wherein the searching of the satellite by using the frequency-dependent beamforming further includes:
determining an access target satellite based on the satellite search result;
acquiring ephemeris data for satellites, and determining values of at least one of the true time delay (TTD) and the phase shifter (PS) using the ephemeris data for the satellites; and
performing data communication through the frequency-dependent beamforming using the values at least one of the determined true time delay (TTD) and phase shifter (PS),
wherein the true time delay (TTD) is mandatory, while the phase shifter (PS) can be used optionally.

5. The low earth orbit satellite communication method using frequency-dependent beamforming of claim 4, wherein in the performing of the data communication by forming a frequency-dependent beam pattern, the data communication is performed by forming a beam pattern fixed at a frequency band of the access target satellite by adjusting values of at least one of the true time delay (TTD) and the phase shifter (PS) based on orbit information and a relative speed of the access target satellite.

6. The low earth orbit satellite communication method using frequency-dependent beamforming of claim 1, wherein in the simultaneously providing of the data service to multiple users by using the frequency-dependent beamforming, beams in different directions are formed for each frequency by adjusting at least one of the true time delay (TTD) and the phase shifter using a Doppler shift pre-calculated based on location information of a ground station,
wherein the true time delay (TTD) is mandatory, while the phase shifter (PS) can be used optionally.

7. A communication system, comprising:
a plurality of antennas;
a plurality of phase shifters connected to respective antennas, respectively;
a plurality of true time delays (TTD) connected to the respective phase shifters, wherein the true time delays and the phase shifters are connected to each other;
an RF chain module processing a transmitted or received signal; and
a signal processing unit controlling frequency-dependent beamforming to be formed by adjusting values of at least one of the true time delay (TTD) and the phase shifter according to respective frequencies by using a Doppler shift pre-calculated based on orbit information of a plurality of satellites, and when signals are received from satellites through the antenna and the RF chain module by using the frequency-dependent beamforming, controlling a satellite to be searched by adjusting values of the true time delay (TTD) and the phase shifter so as to simultaneously amplify signals received in different directions and at different frequencies from the satellites, then accessible satellites are detected through single or few-shot peak detection in the frequency domain,
wherein the true time delay (TTD) is mandatory, while the phase shifter (PS) can be used optionally.

8. A satellite communication system, comprising:
a plurality of antennas;
a plurality of phase shifters connected to respective antennas;
a plurality of true time delays (TTDs) connected to the respective phase shifters, wherein the true time delays and the phase shifters are connected to each other;
an RF chain module processing a transmitted or received signal; and
a signal processing unit controlling frequency-dependent beamforming to be formed by adjusting each of values of at least one of the true time delay (TTD) and the phase shifter so as to form frequency-dependent beams heading to different directions according to a frequency, and simultaneously provide a data service to multiple users by performing the frequency-dependent beamforming,
wherein the true time delay (TTD) is mandatory, while the phase shifter (PS) can be used optionally.
